(19) United States
(12) Patent Application Publication
(10) Pub. No.: US 2001/0054481 A1
(43) Pub. Date: Dec. 27, 2001

(54) Method for making multilayer board having a cavity

(75) Inventors: Hideyuki Harada, Omihachiman-shi (JP); Hiroshi Takagi, Otsu-shi (JP)

Correspondence Address: OSTROLENK FABER GERB & SOFFEN, 1180 AVENUE OF THE AMERICAS, NEW YORK, NY, 100368403

(73) Assignee: Murata Manufacturing Co., Ltd.

(21) Appl. No.: 09/860,020

(22) Filed: May 17, 2001

(30) Foreign Application Priority Data
Jun. 14, 2000 (JP) 2000-178796

(51) Int. Cl. C09J 1/00

(52) U.S. Cl. 156/289

(57) ABSTRACT

In a method for making a multilayer board with a cavity, a composite comprising a plurality of dielectric layers and at least one release layer provided therebetween are formed. Then, a part of the composite is removed to form a cavity having a bottom face defined by the release layer. This method facilitates production of multilayer ceramic boards with cavities having high planarity.

### BACKGROUND OF THE INVENTION

1. Field of the Invention

The present invention relates to a method for making a multilayer board having a cavity for mounting a semiconductor device.

2. Description of the Related Art

In recent years, it has become increasingly important to miniaturize various electronic devices such as mobile telecommunication terminals. This goal has largely been achieved by increasing the integration, versatility and reliability of semiconductor devices such as LSIs which are used in such electronic devices. To further enhance the miniaturization of such electronic devices, the development of high-precision mounting technologies to precisely mount such semiconductor devices on multilayer interconnection boards is required.

Ceramic multilayer boards have been widely used for this purpose because of their high thermal resistance and high interconnection densities. Such multilayer ceramic boards are fabricated by, for example, forming a conductor pattern and via holes on ceramic green sheets, laminating these sheets, compacting the sheets by pressure, and firing the laminate.

In order to reduce the size of various electronic devices, the mounting density of the multilayer ceramic boards must be increased. Particularly, more modular components, including semiconductor devices, must be mounted on the multilayer ceramic boards per unit area. It is particularly desirable to reduce the thickness of the multilayer ceramic boards to accommodate trends toward reduction in size of mobile telecommunication terminals.

This reduction in thickness can be achieved by forming cavities in which the semiconductor devices are mounted. Prior art multilayer ceramic boards of this type are produced by laminating a plurality of ceramic green sheets (each having an opening provided for forming the cavity), compacting the resulting green sheets by pressure, and firing the green compact. According to this process, the cavity is formed in the laminate of the ceramic green sheets before the laminate is compacted under pressure.

This known process often produces cracking in the vicinity of the cavity, a rounding of the side walls of the cavity and/or distortion of the bottom face of the cavity. Such cracks, rounding or distortions precludes or interferes with mounting of the semiconductor devices. Distortion of the bottom face of the cavity inhibits high-precision, high-density mounting of semiconductor devices and is a serious hindrance to improved reliability and a higher mounting density of modular components.

It is likely that the cracking in the vicinity of the cavity and the distortion of the side walls and bottom face of the cavity occur due to the uneven application of pressure to the green sheet laminate during compaction. When a vertical pressure is applied to the green sheet laminate in which the cavity has already been formed, the pressures are different between the cavity and the other areas of the laminate, resulting in the generation of uneven internal stress in the bonded green sheet laminate.

To overcome this problem, some methods for applying a uniform compacting pressure to the entirety of a green sheet laminate have been proposed.

For example, Japanese Unexamined Patent Application Publication No. 9-39160 discloses a method of laminating ceramic green sheets having openings formed therein, evacuating the green sheet laminate between a pair of rubber sheets in a vacuum, and firing the green sheet laminate. According to this method, a uniform pressure can be applied to the green sheet laminate in all directions during compaction by pressure. However, one of the rubber sheets applies an undesired force to the walls of the cavity and may round the corresponding portions. Furthermore, the rubber sheet may reach the bottom corners of the cavity, causing the bottom face to rise.

According to Japanese Unexamined Patent Application Publication No. 8-245268, inorganic powder layers which can be sintered at a temperature above the sintering temperature of a green sheet laminate are provided on the front surface and the back surface and in a cavity of the green sheet laminate. A green sheet having the same shape as the shape of the cavity, and composed of the same material as that of the green sheet laminate, is placed into the cavity and the green sheet laminate is fired after a vertical pressure is applied for compaction in order to prepare a multilayer ceramic board having a cavity.

According to this method, a uniform pressure can be applied to the overall green sheet laminate, reducing the occurrence of deformation and cracking in the vicinity of the cavity while maintaining the planarity of the bottom face of the cavity. However, this method involves many troublesome steps for providing the inorganic powder layer in the cavity and for placing the green sheet in the cavity, resulting in low production efficiency.

### SUMMARY OF THE INVENTION

Accordingly, it is an object of the present invention to provide a method for easily making a multilayer board having a cavity and exhibiting superior planarity with high efficiency.

The present inventors have carefully investigated means for solving the above problems and have found that a cavity having a flat bottom and side faces can be readily and effectively formed by providing a release layer between dielectric layers of a laminate, whereby the release layer inhibits mutual adhesion of the dielectric layers during compaction by pressure, and by removing a part of the laminate so that the release layer defines the bottom face of the cavity.

According to the present invention, a method for making a multilayer board with a cavity comprises the steps of forming a composite comprising a plurality of dielectric layers and at least one release layer provided therebetween, and removing a part of the composite to form a cavity having a bottom face defined by the release layer.

In the preferred method for making a multilayer board with a cavity, a substantially rectangular composite is formed, and then a cavity is formed in the composite. Since a release layer preventing adhesion of the dielectric layers is formed at the position of the bottom face of the cavity between the dielectric layers, the bottom face of the resulting cavity is flat and the formation of the cavity is effective.

After a part of the composite is removed, the release layer may remain, or the part of the composite and the release layer may be removed at the same time.

In the present invention, the release layer is a functional layer which prevents adhesion of the dielectric layers in the composite and facilitates release of the dielectric layers, and must be readily released by, for example, excavation when the part of the composite is removed.

It is preferable that the bonding strength between the composite and the release layer be 0.05 MPa or less. A bonding strength exceeding 0.05 MPa may inhibit the detachment between the dielectric layer and the release layer and may impair the planarity of the bottom face of the cavity. Preferably, the release layer is a ceramic layer, a resin layer, or a metal layer which is composed of materials which are different from that of the dielectric layer. The term dielectric layer as used herein means a dielectric layer having a dielectric constant of at least 1 and may be, for example, a ceramic layer or a resin layer.

### BRIEF DESCRIPTION OF THE DRAWINGS

Other features and advantages of the present invention will become apparent from the following description of the invention which refers to the accompanying drawings.

FIG. 1 is a cross-sectional view of a green ceramic composite according to a first embodiment of the present invention.

FIG. 2 is a cross-sectional view illustrating a state when a knife edge is inserted into positions corresponding to side walls of a cavity in the green ceramic composite of the first embodiment.

FIG. 3 is a cross-sectional view of the green ceramic composite in which a cavity has been formed according to the first embodiment of the invention.

FIG. 4 is a cross-sectional view of a multilayer ceramic board (module component) according to the first embodiment of the present invention.

FIG. 5 is a cross-sectional view of a green ceramic composite according to a second embodiment of the present invention.

FIG. 6 is a cross-sectional view of the green ceramic composite with a cavity of the second embodiment of the present invention.

FIG. 7 is a cross-sectional view of a green ceramic composite according to a third embodiment of the present invention.

FIG. 8 is a cross-sectional view of the green ceramic composite with a cavity in the third embodiment.

### DESCRIPTION OF THE PREFERRED EMBODIMENTS

In the method for making a multilayer board with a cavity in accordance with the preferred embodiments of the present invention, a plurality of ceramic green sheets are laminated to form a green ceramic composite in which a release layer, defining the bottom of a cavity to be formed in the multilayer board, is located between a portion of two adjacent ceramic green sheets. After the ceramic green sheets have been laminated, preferably by compaction, a portion of the green ceramic composite located above the release layer is removed by excavation or the like to form a cavity having a bottom face defined by the release layer. The composite is then sintered to form a multilayer ceramic board with the cavity formed therein.

The green ceramic composite may be, for example, formed of a low-temperature sintering material, such as a composite glass, a crystallized glass, or of a high-temperature sintering type primarily composed of alumina, mulite, aluminum nitride, or silicon carbide. In this case, the release layer is preferably composed of a ceramic material having a composition which is different from that of the green ceramic composite so that it will not be sintered under the firing conditions for sintering the green ceramic composite. In this way, the release layer can easily be removed from the bottom of the cavity after the green ceramic composite has been fired. The release layer may, for example, be a film or sheet and may be formed, for example, by coating or printing.

In the preferred method for making the multilayer board having a cavity formed therein, at least one ceramic green sheet having the release layer and a plurality of ceramic green sheets which do not have any release layer are laminated together to form the green ceramic composite, the green ceramic composite is preferably consolidated by uniform vertical pressure, and a cavity having a bottom face defined by the release layer is formed by excavation or the like.

Since no cavity is formed before the compaction of the green ceramic composite, a uniform pressure can be easily applied to the entire green ceramic composite. Thus, the green ceramic composite does not have undesired residual internal stresses due to uneven pressure loading during the compaction step. Accordingly, after sintering, the cavity does not have cracks and has flat side and bottom faces, enabling high-precision, high-reliability device mounting. Moreover, this method can simplify the compaction step and has wide range of compacting conditions.

When the green ceramic composite is compacted (but not yet sintered), the green ceramic layers located above the release layer are relatively soft and easily formable so that the cavity can be easily formed with smooth side walls. Additionally, the green ceramic composite is relatively fragile and the green ceramic corresponding to the cavity is readily removable.

The cavity is formed after the compaction step and before the ceramic green composite is sintered. In one embodiment, the cavity is formed after compaction but before firing. In this case, it is not necessary to remove the green ceramic composite from the firing furnace. This process contributes to improved production efficiency compared with the process of forming the cavity after calcining but before sintering. Accordingly, the unsintered ceramic portion to be removed exhibits excellent handling properties.

In a second embodiment, the cavity is formed after the green ceramic composite has been partially fired, so as to calcinate the green ceramic composite (and remove binder from the composite), but before the composite is sintered. To this end, the green ceramic composite is placed in the furnace and partially fired so as to calcinate the composite. The green ceramic composite is then removed from the furnace and the cavity is formed. At this point, the green ceramic layers located above the release layer are sufficiently soft and formable so that the cavity can be easily formed with smooth sidewalls. The green ceramic corresponding to the cavity is easily movable. After the cavity has been formed, the green ceramic composite is returned to the furnace (alternatively to a separate furnace) and further fired to sinter the composite.

In the method for making a multilayer board in accordance with the preferred embodiments of the present invention, one or more knife edges are inserted from one main surface of the composite toward the release layer and a part of the composite is removed to remove the ceramic green layers located above the release layer to form a cavity having the bottom face defined by at least part of the release layer. Since the release layer inhibits bonding of dielectric layers located immediately above and below the release layer, it is easy to remove the portion of the dielectric layers located above the release layer and between the slits formed by the knife edges.

In one preferred embodiment of the present invention, a non-sinterable restraining layer (comprising a non-sinterable powder, i.e., one which is substantially unsintered under the firing conditions for the green ceramic composite) is provided on at least one main surface of the green ceramic composite. The green ceramic composite is fired under the firing conditions therefor so that the green ceramic composite is sintered while both the release layer and the non-sinterable layer remain unsintered. Thereafter, the non-sinterable restraining layer is removed to obtain a ceramic composite with substantially no firing shrinkage in the planar direction.

The non-sinterable layer is preferably formed of a power (e.g., alumina or zirconia) which remains substantially rigid (i.e., it does not shrink) but unsintered under the firing conditions for the green ceramic composite and which is a porous layer composed of non-sinterable powder after the firing. It is believed that the glass component in the substrate penetrates into the nonsinterable layer forming an extremely thin glass layer between the sinterable layer and the green ceramic composite. This thin glass layer appears to prevent shrinkage of the composite. Since the foregoing method is a so-called non-shrinkage process, the resulting cavity is significantly flat and the multilayer ceramic board has significantly high precision with reduced firing shrinkage in the planar direction.

It is preferable that the release layer be primarily composed of a non-sinterable powder which is not sintered under the firing conditions for the green ceramic composite. When the green ceramic portion corresponding to the cavity is removed from the green ceramic composite, the release layer, primarily composed of the non-sinterable powder, which remains at the bottom face of the cavity, has the same function as that of the outer non-sinterable layer, resulting in a multilayer ceramic board having higher precision. Also, the release layer may be a sheet or may be formed by printing using a paste. When the material for the release layer is the same as that for the non-sinterable layer, the number of the materials to be used can be reduced, enabling high-efficiency production of multilayer ceramic boards.

In the present invention, the plurality of dielectric layers may have a plurality of release layers so that the cavity is a stepped cavity having a plurality of bottom faces defined by the respective release layers. That is, a plurality of dielectric layers have respective release layers for forming a bottom face of the cavity so that a multilayer board (particularly a multilayer ceramic board) with a stepped cavity having bottom faces can be produced.

The method for making the multilayer board having a cavity may include a step for mounting a semiconductor device into the cavity. Since the cavity exhibits superior planarity as described above, the multilayer board is also applicable to high-precision mounting of bare-chip-type semiconductor devices and the like, such that compact reliable module components can be produced.

The method for making the multilayer board having a cavity in accordance with the present invention will now be described in more detail with reference to the following embodiments.

First Embodiment

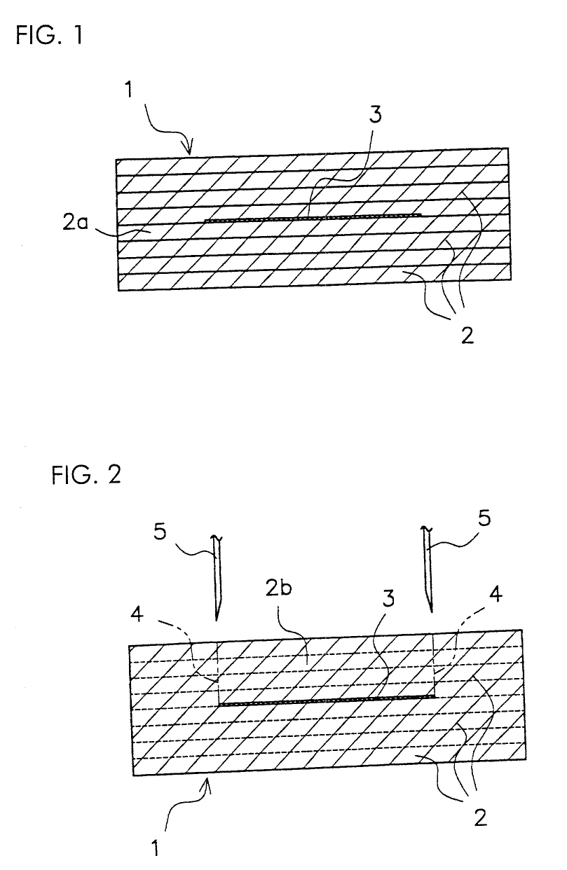

A glass powder, a ceramic filler, and an organic vehicle are mixed to prepare a slurry composition. The slurry composition is shaped into a sheet by a doctor blade process to form low-temperature-sinterable ceramic green sheets 2 and 2a. The ceramic green sheets 2 and 2a may be provided with interconnection conductive patterns formed, for example, of Ag or Cu and via holes, if necessary. An alumina paste is applied to a portion of the ceramic green sheet 2a corresponding to the bottom face of the cavity to form a release layer 3. As shown in FIG. 1, the ceramic green sheet 2a having the release layer 3 and the ceramic green sheets 2 which do not have a release layer are laminated to form a green ceramic composite 1.

The green ceramic composite 1 is placed into a mold and is preferably compacted at a temperature of 60° C. and a pressure of 2,000 kgf/cm² which is applied from the upper face of the mold through a push plate. By this compaction treatment, the ceramic green sheets are mutually bonded and consolidated except for the portion provided with the release layer 3.

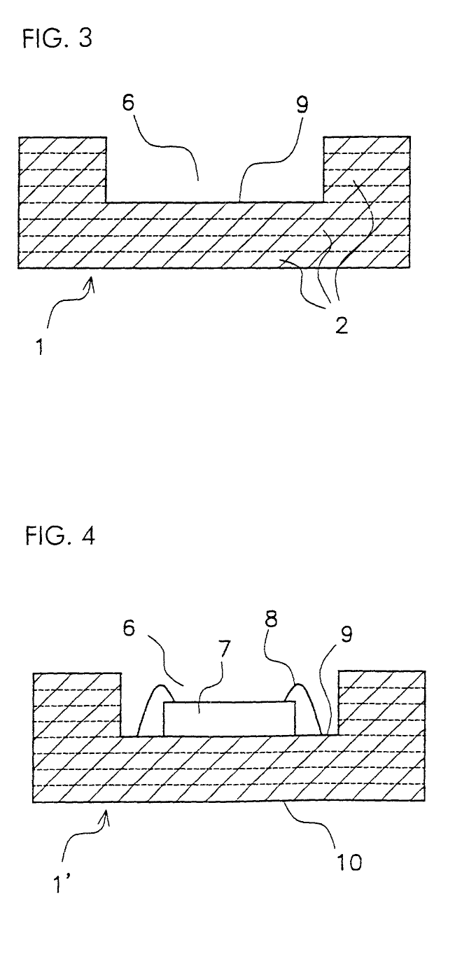

As shown in FIG. 2, one or more knife edges 5 are inserted into positions of the compacted green ceramic composite 1 corresponding to side walls of the cavity to form slits preferably having a height corresponding to the depth of the cavity. A sufficient number of slits are formed to create all of the sidewalls of the cavity. Since the release layer 3 is formed at a position corresponding to the bottom face of the cavity and prevents mutual bonding of the ceramic layers located on either side of the release layer, the green ceramic 2b corresponding to the cavity 6 is readily removable. As shown in FIG. 3, the green ceramic composite 1 has a cavity 6 having a bottom face 9 which is preferably substantially square when viewed from the top, although this is not shown in the drawing.

The green ceramic composite 1 having the cavity 6 is subjected to binder removal treatment and then to firing treatment. For example, the binder removal treatment may be performed at 450° C. for 4 hours and the firing treatment may be at 860° C. for 20 minutes. Preferably, the binder removal treatment is performed at 200 to 600° C. and the firing treatment is performed at 800 to 1,000° C.

As shown in FIG. 4, the green ceramic composite 1 is sintered to form a sintered ceramic compact 1′ and a multilayer ceramic board 10 having a cavity 6 is thereby prepared. A semiconductor device 7 is then mounted in the cavity 6, and the semiconductor device 7 and the multilayer ceramic board 10 are connected via wires 8 to complete a multilayer ceramic board 10 mounting the semiconductor device 7 (a module component).

According to this embodiment, since a uniform pressure is applied to the entire green ceramic composite 1 during compaction, the resulting cavity has a flat bottom face and does not have rounded side walls. Specifically, the cavity has a superior planarity of approximately 20 μm/10 mm or less in the vertical and horizontal directions after firing, enabling high-precision device mounting.

Second Embodiment

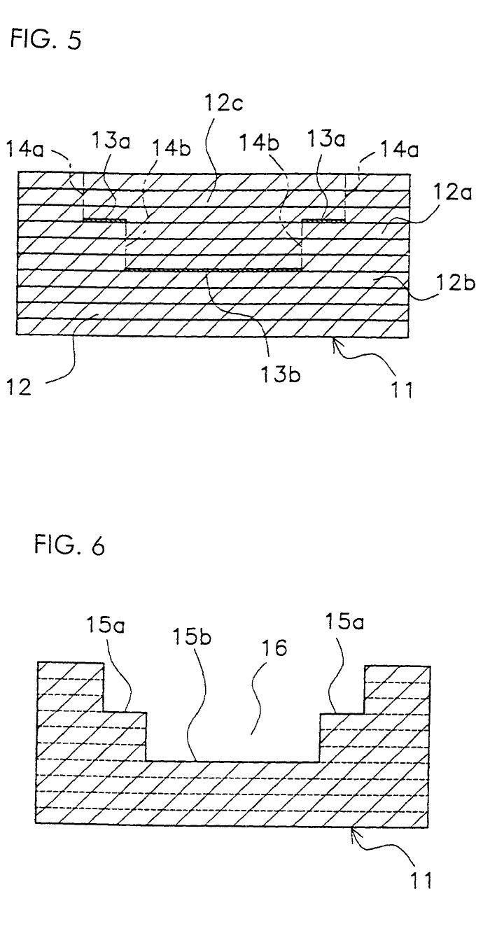

As shown in FIG. 5, a green ceramic composite 11 having release layers 13a and 13b is formed as in the first embodiment. The green ceramic composite 11 is formed by laminating a ceramic green sheet 12a having the release layers 13a, a ceramic green sheet 12b having the release layer 13b, and ceramic green sheets 12 having no release layer.

The green ceramic composite 11 is placed into a predetermined mold and is compacted under the conditions which are the same as those in the first embodiment to mutually bond and consolidate the ceramic green sheets except for the positions provided with the release layers 13a and 13b.

One or more knife edges 5 are inserted into positions 14aa, which correspond to side walls from first bottom faces 15a, and positions 14b, which correspond to side walls from a second bottom face 15b, as in the first embodiment. Since the release layers 13a and 13b are formed at the positions corresponding to the first bottom faces 15a and the second bottom face 15b, respectively, to prevent mutual bonding of the ceramic layers, the green ceramic 12c corresponding to the stepped cavity is readily removable. As a result, as shown in FIG. 6, a green ceramic composite 11 having a stepped cavity 16 with a first bottom faces 15a and a second bottom face 15b can be formed.

After removing the binder and firing, a multilayer ceramic board having the stepped cavity can be prepared as in the first embodiment. Moreover, a semiconductor device is preferably mounted to prepare a multilayer ceramic board mounting the semiconductor device (module component).

According to this embodiment, a uniform pressure is applied to the entire green ceramic composite 11 during compaction, hence, the resulting stepped cavity has flat bottom faces and does not have rounded side walls.

Third Embodiment

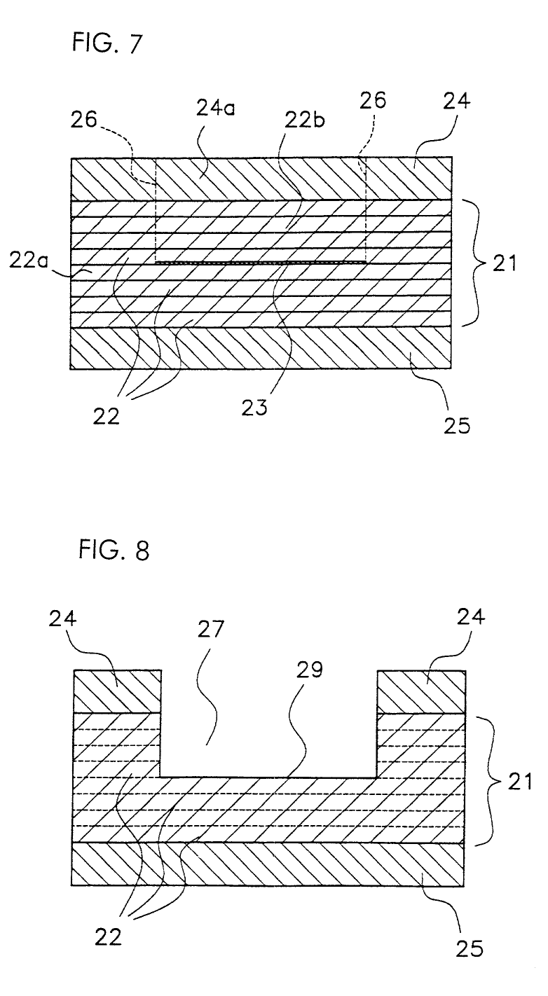

With reference to FIG. 7, a ceramic green sheet 22a having a release layer 23 and ceramic green sheets 22 having no release layer are laminated as in the first embodiment to form a green ceramic composite 21 provided with the release layer 23 substantially in the center thereof. Constraining layers 24 and 25 are respectively bonded onto the opposite main faces of the green ceramic composite 21. Each of the constraining layers 24 and 25 is preferably a laminate of a plurality of ceramic green sheets which are primarily composed of alumina and are not sintered at the firing temperature of the green ceramic composite 21.

The green ceramic composite 21 provided with the constraining layers 24 and 25 is placed into a mold and is compacted under the conditions shown in the first embodiment. The ceramic green sheets are mutually bonded and consolidated except for the portion provided with the release layer 3.

One or more knife edges are inserted into positions 26 of the compacted green ceramic composite 21 corresponding to side walls of the cavity to form slits corresponding to the height of the cavity. Since the release layer 3 is formed at the position corresponding to the bottom face of the cavity, the green ceramic 22b with a part 24a of the constraining layer 24 corresponding to the cavity 27 is readily removable. As shown in FIG. 8, the green ceramic composite 21 has the cavity 27 having the bottom face 29 at the predetermined position thereof.

After removing the binder, firing is performed as in the first embodiment. Next, the constraining layers 24 and 25, which are changed to porous layers during firing, are removed by wet honing or the like to complete a multilayer ceramic board with the cavity formed therein. Finally, a semiconductor device is mounted to prepare a multilayer ceramic board mounting the semiconductor device (module component).

According to this embodiment, a uniform pressure is applied to the entire green ceramic composite 21 during compaction; hence, the resulting cavity has flat bottom faces and does not have rounded side walls. Since the green ceramic composite provided with the constraining layers, which are not sintered at the firing temperature for the green ceramic composite, the shrinkage during firing in the planar direction can be suppressed and the resulting multilayer ceramic board has significantly high precision.

Although the present invention has been described with reference to three embodiments, the present invention is not limited to these embodiments.

For example, the portion corresponding to the cavity may be removed after firing the green ceramic composite. That is, the green ceramic composite provided with the release layer is compacted and consolidated, and slits are formed at portions corresponding to the side walls of the cavity. A releasing agent having a release function after firing is loaded into the slits and the sintered portion corresponding to the cavity is removed after firing, wherein the releasant is primarily composed of a non-sinterable material such as alumina when the green ceramic composite is composed of a ceramic which is sinterable at low temperature.

In the above embodiments, the knife edge is inserted to form slits at the portions corresponding to the side walls of the cavity. Alternatively, the slits may be formed using laser. In such a case, the release layer preferably absorbs laser light. Any other suitable device may also be used to form the slits.

The mounting of semiconductor devices is not limited to mounting via wire bonding and may, by way of example, be flip-chip mounting or chip-size package mounting.

The method for making the multilayer board with the cavity of the present invention is not limited to the method for making the multilayer ceramic board and is also applicable to a method for making a resin multilayer board with a cavity, such as a printed circuit board. The multilayer ceramic board may be formed by laminating sheets or by printing a thick film.

Although the present invention has been described in relation to particular embodiments thereof, many other variations and modifications and other uses will become apparent to those skilled in the art. It is preferred, therefore, that the present invention be limited not by the specific disclosure herein, but only by the appended claims.

What is claimed is:

1. A method for making a multilayer board having a cavity, the method comprising:
forming a composite comprising a plurality of dielectric layers and at least one release layer provided between at least one adjacent pair of the dielectric layers; and
forming a cavity having a bottom face defined by the release layer by removing a portion of the composite located above at least a portion of the release layer.

2. A method for making a multilayer board having a cavity according to claim 1, wherein the composite is a green ceramic composite comprising a laminate of a plurality of ceramic green sheets, and the cavity is formed by removing a part of the green ceramic composite.

3. A method for making a multilayer board having a cavity according to claim 2, wherein the green ceramic composite is formed by laminating the plurality of ceramic green sheets by applying uniform pressure.

4. A method for making a multilayer board according to claim 3, wherein the ceramic green sheets are stacked one atop the other and wherein the uniform pressure is applied in the stacking direction.

5. A method for making a multilayer board having a cavity according to claim 2, wherein the cavity is formed by inserting one or more knife edges from one main surface of the composite toward the release layer to form slits in the composite and removing the portion of the composite located between the slits and the release layer.

6. A method for making a multilayer board having a cavity according to claim 5, wherein the bonding strength between the composite and the release layer is 0.05 MPa or less.

7. A method for making a multilayer board having a cavity according to claim 2, wherein the green ceramic composite has first and second planar main surfaces which are parallel to one another and wherein a restraining layer, which is not sintered under a set of firing conditions under which the green ceramic composite is fired, is provided on at least one main surface of the green ceramic composite, and wherein the method further comprises firing the green ceramic composite having the cavity formed therein to sinter the green ceramic composite and removing non-sinterable layer after the green ceramic composite has been formed to obtain a sintered ceramic composite exhibiting substantially no firing shrinkage in the planar direction of the first and second main surfaces.

8. A method for making a multilayer board having a cavity according to claim 7, wherein the release layer is made of the same material as the restraining layer.

9. A method for making a multilayer board having a cavity according to claim 1, wherein at least two of the dielectric layers each have at least one respective release layer formed therein and the cavity is a stepped cavity having bottom faces defined by the release layers.

10. A method for making a multilayer board having a cavity according to claim 9, wherein the cavity is formed by forming at least one slit defining the walls of the cavity, the at least one slit extending from one major surface of the composite toward the release layer, and removing the portion of the composite located between the at least one slit and the release layer.

11. A method for making a multilayer board having a cavity according to any one of claims 1 to 10, wherein a semiconductor device is mounted into the cavity.
